(19) United States
(12) Patent Application Publication
(10) Pub. No.: US 2018/0107956 A1
(43) Pub. Date: Apr. 19, 2018

(54) SYSTEM, INFORMATION PROCESSING DEVICE, AND INFORMATION PROCESSING METHOD

(71) Applicant: Kazuhiro YAMADA, Kanagawa (JP)

(72) Inventor: Kazuhiro YAMADA, Kanagawa (JP)

(73) Assignee: Ricoh Company, Ltd., Tokyo (JP)

(21) Appl. No.: 15/718,433

(22) Filed: Sep. 28, 2017

(30) Foreign Application Priority Data
Oct. 19, 2016 (JP) 2016-205229

(51) Int. Cl. G06Q 10/06; H04L 29/08

(52) U.S. Cl. CPC G06Q 10/0633; H04L 67/10

(57) ABSTRACT

A system includes first apparatus disposed within a site, and a second apparatus disposed outside of the site and communicably connected with the first apparatus through a network. The first apparatus includes first circuitry and a first memory. The second apparatus includes second circuitry and a second memory to receive and store definition information defining a plurality of processes to be performed. The first circuitry acquires the definition information from the second memory, and stores the acquired definition information in the first memory. The first circuitry and the second circuitry cooperate with each other to determine, for each one of the plurality of processes defined by the definition information, a device to execute the process according to the definition information and control the device to perform the process. When the device to execute the process is disposed within the site, the first circuitry controls the device to perform the process.

### CROSS-REFERENCE TO RELATED APPLICATION

This patent application is based on and claims priority pursuant to 35 U.S.C. § 119(a) to Japanese Patent Application No. 2016-205229, filed on Oct. 19, 2016, in the Japan Patent Office, the entire disclosure of which is hereby incorporated by reference herein.

### BACKGROUND

### Technical Field

The present disclosure relates to a system, an information processing device, and an information processing method.

### Related Art

A flow of a daily job, a procedure, or the like is referred to as a workflow. Such a workflow may be automated with an information processing device and this is referred to as a workflow system. The workflow system executes processing according to workflow information that defines what kind of processes are performed. The workflow information defines a plurality of processes to be processed by a plurality of information processing devices, which cooperate with one another.

To execute the processing by the workflow system, it is necessary for an administrator of the workflow system to define and edit workflow information, using a device such as an administrator terminal connecting to the workflow system.

With improved network communication environment and reduced communication costs, services such as a service for saving data on the Internet and a service provided via the Internet have multiplied rapidly. Such a service related to the Internet is referred to as a cloud service or, simply, cloud or cloud-based. On the other hand, a service executed, for example, with a device or a system at a given site, in-house, is referred to as on-premise.

In recent years, not only the on-premise but also the cloud, which is implemented with resources external to the site, are used for implementing the workflow system. However, with an on-premise workflow system it is difficult to register workflow information from outside the site. In contrast, the cloud-based workflow system has an advantage in that the administrator can register the workflow information from any desired place.

### SUMMARY

A system includes first apparatus disposed within a site, and a second apparatus disposed outside of the site and communicably connected with the first apparatus through a network. The first apparatus includes first circuitry and a first memory. The second apparatus includes second circuitry and a second memory to, respectively, receive and store, definition information defining a plurality of processes to be performed. The first circuitry acquires the definition information from the second memory, and stores the acquired definition information in the first memory. The first circuitry and the second circuitry cooperate with each other to determine, for each one of the plurality of processes defined by the definition information, a device to execute the process according to the definition information and control the device to perform the process. When the device to execute the process is disposed within the site, the first circuitry controls the device to perform the process, and when the device to execute the process is disposed outside of the site, the second circuitry controls the device to perform the process.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic illustration of a workflow system according to one of the embodiments of the disclosure;

FIG. 2 is a block diagram illustrating one example of a configuration of the workflow system;

FIG. 3 is a schematic diagram illustrating processes defined in workflow information and device that executes processing each of which processes a corresponding one of the processes;

FIG. 4 is a block diagram illustrating one example of a hardware configuration of an on-premise server, a cloud server, a cloud workflow management server, and an administrator terminal;

FIG. 5 is a schematic block diagram illustrating one example of a hardware configuration of a multifunction peripheral (MFP);

FIG. 6 is a block diagram illustrating one example of a functional configuration of the on-premise server and the cloud server;

FIG. 7 is a block diagram illustrating one example of a functional configuration of the cloud workflow management server and the administrator terminal;

FIG. 8 is a block diagram illustrating a functional configuration of the MFP;

FIG. 9 is a sequence diagram illustrating an operation of setting workflow information executed by an administrator;

FIG. 10A and FIG. 10B are illustrations of a workflow setting screen;

FIG. 11 is an illustration of a setting screen;

FIG. 12 is a sequence diagram illustrating example operation of updating workflow information set by the administrator, automatically with the on-premise server;

FIG. 13 is a flowchart illustrating operation of the on-premise server determining whether the workflow information is to be updated;

FIG. 14 is a sequence diagram illustrating operation of the workflow system executing workflow processing; and

FIG. 15A, FIG. 15B, and FIG. 15C are illustrations of a screen to be displayed on, for example, a control panel of the MFP when the workflow processing is executed.

The accompanying drawings are intended to depict example embodiments of the present disclosure and should not be interpreted to limit the scope thereof. The accompanying drawings are not to be considered as drawn to scale unless explicitly noted.

### DETAILED DESCRIPTION

The terminology used herein is for describing particular embodiments only and is not intended to be limiting of the present disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operation in a similar manner, and achieve a similar result.

A workflow system 100 according to embodiments of the disclosure and an information processing method performed by the workflow system 100 are described with reference to the attached drawings below.

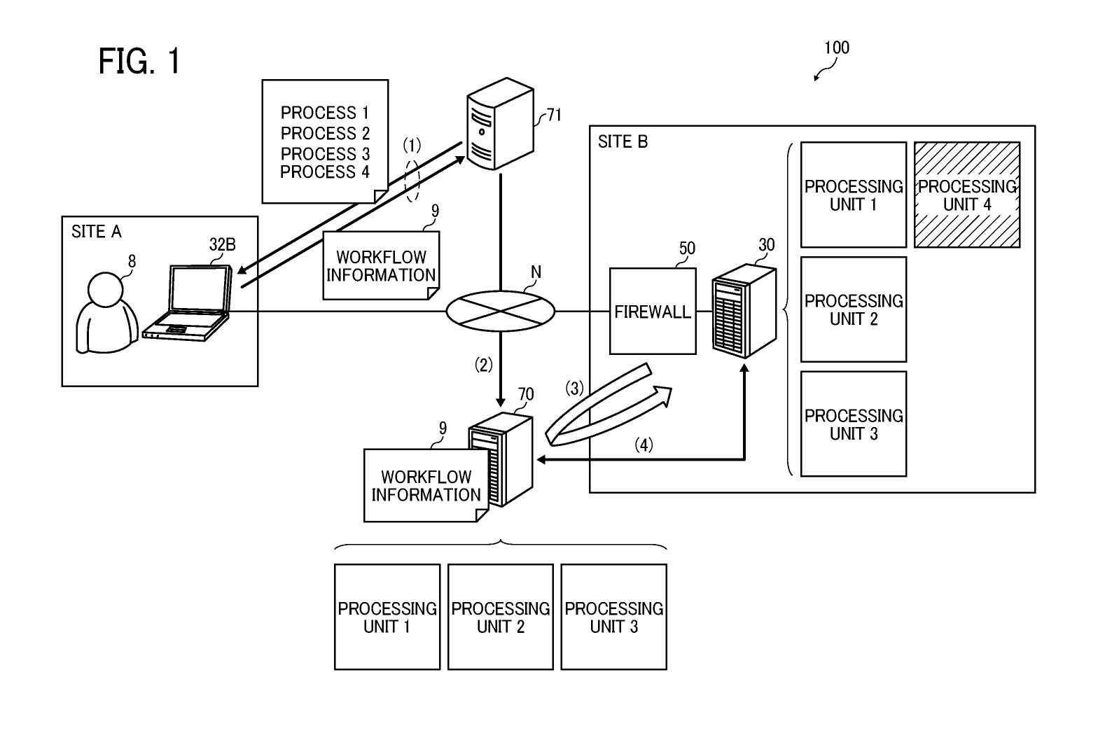

FIG. 1 is a schematic illustration of the workflow system 100 according to an example embodiment. A cloud workflow server (hereinafter referred to as a cloud server) 70 and a cloud workflow management server 71 reside on the Internet N, and an on-premise workflow server (hereinafter referred to as an on-premise server) 30 resides on on-premise indicated as a site B. The cloud server 70 is able to perform processes 1 to 3, and the on-premise server 30 is able to perform processes 1 to 4. The processes 1 to 4 are a unit of processing performed by the workflow system 100, and the processes 1 to 3 are in common to the cloud and on-premise. The process 4 is a process that is preferably performed in an on-premise side, for example, a process of saving data in a shared folder such as a Network Attached Storage (NAS) installed in-house, in a company. Additionally, the site B is a place or an area where there is a system constructed inside of a firewall 50 (within a site) (e.g., inside of a company). A site A may be any desired place (e.g., inside of any desired facility, on any desired street, inside of any desired mobile object), as long as the site A is outside of the site B (external to the site B).

(1) An administrator 8 at the site A operates an administrator terminal 32B to cause the administrator terminal 32B to communicate with the cloud workflow management server 71 and defines a workflow, or a job, using the processes 1 to 4. The administrator 8 sets how the workflow system 100 operates, namely how the processes 1 to 4 are combined. Information obtained from this setting is workflow information 9. Hereinafter, the workflow information 9 may indicate a definition of a unit of processing, workflow, as described above, and may collectively indicate a set of definitions each of which is for a unit of processing, workflow. The administrator terminal 32B transmits the workflow information 9 to the cloud workflow management server 71.

(2) The cloud workflow management server 71 transfers the workflow information 9 to the cloud server 70. The cloud server 70 stores the workflow information 9.

(3) The on-premise server 30 acquires the workflow information 9 from the cloud server 70. The on-premise server 30, accordingly, executes workflow processing (workflow) according to the workflow information 9 registered in the cloud server 70. That is, the on-premise server 30 set in the on-premise side downloads the workflow information 9 from a cloud side, and executes the workflow processing. This allows the administrator 8 to register and edit the workflow information 9 by connecting to the Internet N. Additionally, this eliminates a number of settings of the workflow information 9 corresponding to the number of the on-premise servers 30.

(4) The on-premise server 30 starts executing the workflow processing, namely performing the processes defined, and, when there is a process to be performed by the cloud server 70, the on-premise server 30 can request to the cloud server 70 beyond the firewall 50 for performing the process. The cloud is provided with a server having the same configuration as a server provided in the on-premise, namely, a configurations of the cloud server 70 and a configuration of the on-premise server 30 are same, so that the cloud server 70 also can perform the processes as the cloud server does according to the workflow information 9.

As described above, the on-premise server 30 and the cloud server 70 can execute a single unit of workflow processing, a job, according to the workflow information 9 by cooperating with each other.

### <Terminology>

“Definition information” used in the claims is information in which at least two processes to be performed by one or more information processing devices are defined. More specifically, the definition information defines contents of a series of a plurality of processes, an order of the plurality of processes to be performed, and the one or more information processing devices each of which is to be a device that executes processing to execute a corresponding one of the plurality of processes. In the description of the embodiments, workflow information is used to represent the definition information.

“Process” here indicates obtaining useful information by calculating given data or using the given data for control of devices.

“System” is defined as a mechanism implemented with a plurality of devices operating in conjunction with each other to function as a whole. In the description of the embodiments, the workflow system 100 represents the system.

“Site” is a place or an area where an operation base is. An area where a device or an apparatus used for the on-premise is set is the site, and the device or apparatus in the on-premise is a device or apparatus being within the site. Other devices or apparatus that are not within the on-premise are the devices or apparatuses being outside of the site. Alternatively, an area inside of a firewall may be defined as within the site. Examples of the site includes an inside of a company, an inside of a facility, an inside of a department, and an inside of a room. An outside of the site is, for example, a cloud environment, however, an area that is not included in the site in the facility also may be regarded as the outside of the site.

### <Example of System Configuration>

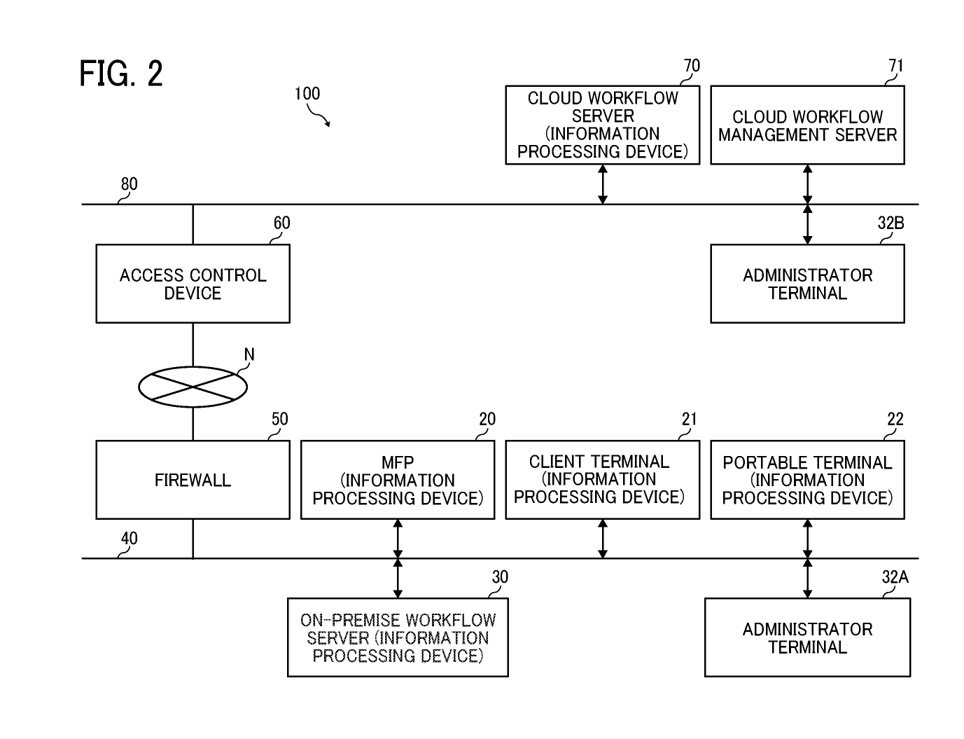

FIG. 2 is a block diagram illustrating a system configuration of the workflow system 100. The workflow system 100 includes, for example, a multifunction peripheral (MFP) 20, a client terminal 21, a portable terminal 22, the on-premise server (on-premise workflow server) 30, an administrator terminal 32A, the firewall 50, an access control device 60, the cloud server (cloud workflow server) 70, the administrator terminal 32B, and the cloud workflow management server 71. Either one of the administrator terminals 32A or 32B is enough to configure the system.

In FIG. 2, components, namely devices, illustrated lower than the Internet N are provided as facilities that are managed by a user (e.g., a company) of the workflow system 100, and these correspond to the site B of FIG. 1. The facilities managed by the user (e.g., company) are collectively referred to as on-premise. The term “cloud” (or “cloud computing”), is generally used in contrast to the term “on-premise”. The term “cloud computing” indicates information processing performed using resources of the Internet N. As specific aspects of the cloud computing include Software as a service (SaaS) and Infrastructure as a Service (IaaS), any desired aspect may be applied to the embodiments.

The firewall 50, the MFP 20, the client terminal 21, the portable terminal 22, the on-premise server 30, and the administrator terminal 32A are connected to each other through a network 40. The network 40 is, for example, a Local Area network (LAN), wide-area Ethernet, or a Wide Area Network (WAN) that is connected to the LAN via a rooter. The network 40 is a network that is inside of the firewall 50, with respect to the Internet N that is the outside of the firewall 50. The network 40 may be a wired network or a part of or all of the network may be a wireless network.

The access control device 60, the cloud server 70, the cloud workflow management server 71, and the administrator terminal 32B are connected to each other through a network 80. The network 80 is outside of the Internet N when viewed from the facilities, which are managed by the user (company), referred to as a cloud environment, and corresponding to, for example, a network in a data center. The network 80 may be a part of the Internet N. The Internet is a worldwide network that can connect computers each other in all over the world.

The MFP 20 is an apparatus that has at least two functions of scanning, printing, and facsimile communicating, to provide multiple functions. The MFP 20 may be replaced with an apparatus that has a single function selected from the above-described functions. The MFP 20 may be referred to as an image forming apparatus, a multifunction printer, a copier, or office equipment. The MFP 20 may further include a communication function, a display function, and an input function. The MFP 20 may perform a part of workflow processing when the workflow processing is executed. The MFP 20 serves as an information processing device that processes data according to a program that may be stored in advance. The MFP 20, for example, scans a document, converts an image of the document into image data, and performs data processing on the converted image data according to the program.

The MFP 20 is provided as an apparatus that inputs an image (generates an image data) and outputs the image, however other apparatuses than the MFP 20 may be replaced with the MFP 20 and connected to the network 40. For example, a videoconference terminal, an electronic whiteboard, a projector, or a digital signage may be replaced with the MFP 20, or provided in addition to the MFP 20.

The client terminal 21 is an information processing device, such as a desktop type computer, a note type computer, and a workstation. The client terminal 21 further includes a communication function, a display function, and an input function. The client terminal 21 processes data according to a program that may be stored in advance to function as the information processing device.

The portable terminal 22 is still another information processing device that is portable, such as a smart phone, a tablet terminal, a mobile phone, a digital camera, and a wearable personal computer (PC). The portable terminal 22 may not need to be actually carried by a user. The portable terminal 22 further includes a communication function, a display function, and an input function. The portable terminal 22 serves as information processing device by processing data according to a program that may be stored in advance.

The MFP 20, the client terminal 21, and the portable terminal 22 can request to the on-premise server 30 to execute the workflow processing. In general, the user operates these devices, which include the MFP 20, the client terminal 21, and the portable terminal 22, to select a workflow and execute workflow processing according to the selected workflow. Alternatively, an application may automatically request for the execution of the workflow processing instead of the user operation.

Devices that can request for execution of the workflow processing to the on-premise server 30 are not limited to the MFP 20, the client terminal 21, and the portable terminal 22, but alternatively may be other information processing devices.

The on-premise server 30 is implemented with one or more computers and there may be more than two on-premise servers 30. The on-premise server 30 includes a communication function and serves as an information processing device (first information processing device) that processes data according to a program that may be stored in advance. The on-premise server 30 stores the workflow information 9.

The workflow information 9 defines contents of a series of a plurality of processes, an order of the plurality of processes to be performed, and devices that execute processing each of which is an information processing device that performs corresponding one of the plurality of processes. The workflow information 9 may define selected one or more of the information processing devices including the MFP 20, the client terminal 21, and the portable terminal 22 as a device that executes processing. That is, each of the MFP 20, the client terminal 21, and the portable terminal 22 can request for the execution of the workflow processing and also can be the device that executes processing for the corresponding process.

The on-premise server 30 supplies a list of the workflow information 9, namely a list of workflows or units of processing defined with a piece of the workflow information 9, to these information processing devices (MFP 20, client terminal 21, and the portable terminal 22). Subsequently, one of the information processing devices selects a workflow (workflow information 9) from the list and requests to the on-premise server 30 for the execution of workflow processing. The on-premise server 30 and the one of the information processing device perform a plurality of processes defined in the workflow information 9 by cooperating with each other. More specifically, the on-premise server 30 and the one of the information processing devices, which requests the execution of the workflow processing, cause an information processing device defined as a device that executes processing in the workflow information 9, to perform a corresponding one of the plurality of processes defined in the workflow information 9, in an order defined in the workflow information 9. The on-premise server 30 and the one of the information processing apparatus, which requests the execution of the workflow processing, transmit and receive data to be processed via the network 40 when the device that executes processing is changed.

Additionally, when there is no definition regarding a device that executes processing in the workflow information 9, the on-premise server 30 and the one of the information processing devices, which requests the execution of the workflow processing, cause one of the information processing devices selected in accordance with conditions that are set in advance in the workflow information 9. In this case, the on-premise server 30 and the one of the information processing devices, which requests the execution of the workflow processing, have a table in which each of the plurality of processes and a corresponding one of the information processing devices to perform the process as a device that executes processing are stored in association with each other. The table is used for determining one of the information processing devices for each process appropriately. When two or more information processing devices are able to perform the same process, one of the two or more information processing devices is selected according to predetermined determination conditions. Selecting according to the predetermined determination conditions includes, for example, selecting one that is in the same network, selecting one that is not being used, and selecting one that is energy-efficient.

The firewall 50 monitors a packet sent from the Internet N to the network 40 and from the network 40 to the Internet N to allow the packet to pass or discard the packet. More specifically, the firewall 50 discards a packet that is from the network 80 and lets a packet that is from the network 40 pass. Additionally, the firewall 50 allows a packet that is a response from the network 40 to pass in response to the packet from the network 80. In addition, the firewall 50 includes general functions.

The administrator terminal 32A is an information processing device that is operated by the administrator 8. The administrator 8 is a person who manages the entire workflow system 100, and mainly defines and edits the workflow information 9. The user is a person who executes the workflow processing. The administrator 8 and the user do not need to be distinguished strictly and the administrator 8 may be the user.

Additionally, the administrator terminal 32A and the administrator terminal 32B are distinguished by connection, which one of the network 40 and the network 80 is connected, and these terminals may be actually the same one.

The cloud workflow management server 71 is one or more information processing devices. The cloud workflow management server 71 is a Web server that provides screen data that is used for defining the workflow information 9. The administrator terminal 32A defines the workflow information 9 according to operation of the administrator 8 and transmits the workflow information 9 (or information required for defining the workflow information 9) to the cloud workflow management server 71.

The cloud server 70 is implemented with one or more computers, and there may be more than two cloud servers 70. The cloud server 70 includes a communication function and serves as an information processing device (second information processing device) that processes data according to a program that may be stored in advance. The cloud server 70 stores the workflow information 9 obtained from the cloud workflow management server 71. The cloud workflow management server 71 may be integrally configured with the cloud server 70.

The cloud server 70 has substantially the same functions as the on-premise server 30. That is, the cloud server 70 executes workflow processing in the cloud side by cooperating with various types of services in the cloud. When a process defined in the workflow is to be executed in the on-premise, the cloud server 70 transmits data to be used for performing the process to the on-premise server 30. Additionally, the MFP 20, the client terminal 21, and the portable terminal 22 may be connected to the network 80.

The access control device 60 authenticates the information processing devices (the MFP 20, the client terminal 21, and the portable terminal 22) within the network 40 and the on-premise server 30 to access the network 80. That is, the access control device 60 accesses the cloud server 70, and authenticates for executing the workflow processing with the on-premise server 30 and the cloud server 70 by operating in conjunction with each other. In the authentication, a user identification (ID) and a password, or a cord called an organization cord that is assigned to each organization in addition to the user ID and the password are used. The on-premise server 30 and each information processing device in the network 40 can access the cloud server 70 in the network 80 when being authenticated with the access control device 60.

<Processes and Device that Executes Processing Defined in Workflow Information>

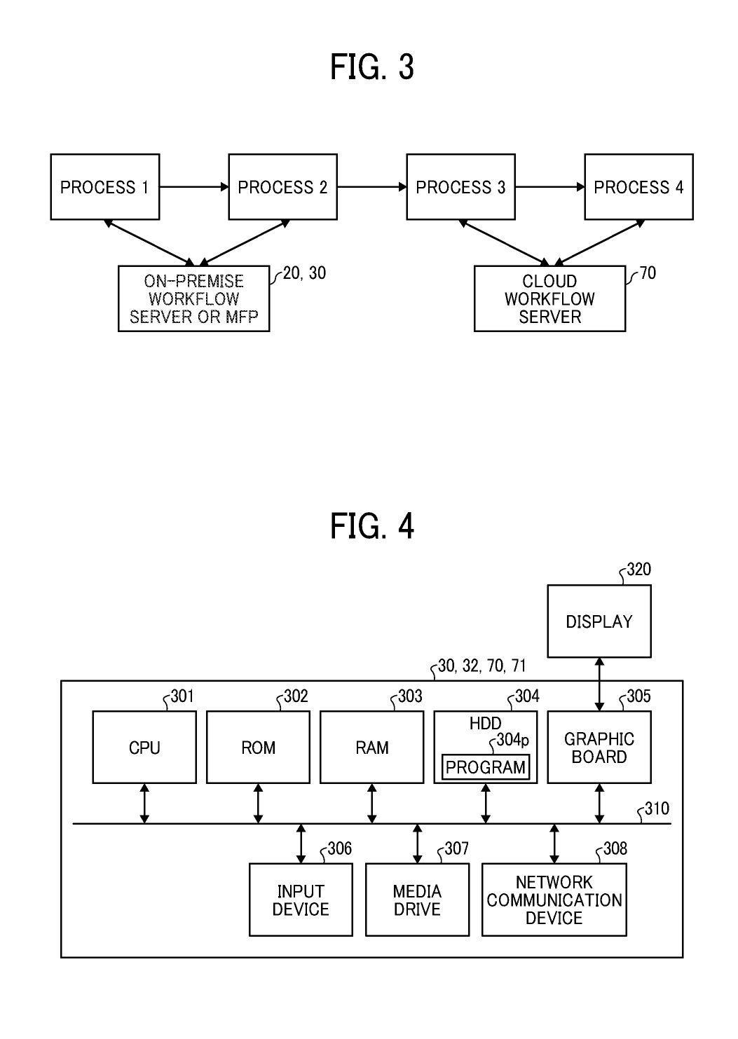

FIG. 3 is a schematic diagram illustrating processes defined in the workflow information 9 and devices that execute processing each of which performs corresponding one or more processes defined. As one example of a process included in the workflow information 9, retrieving data (for example, scanning, image capturing, mail receiving, and facsimile receiving) is defined.

Additionally, as another example of such a process included in the workflow information 9, processing data (for example, compression of data, optical character recognition (OCR), filtering, data synthesizing, coding into a specific data format, conversion into a specific file format (e.g., Portable Document Format (PDF) processing)) is defined.

Additionally, as still another example of such a process included in the workflow information 9, externally outputting data (for example, printing, displaying, audio output, distributing data to a server (uploading), and mail distribution) is defined.

The workflow information 9 defines an order of performing the plurality of processes. Each information processing device, which performs one or more corresponding processes, receives target data that is a result of a former process, and performs processing on the received target data. The target data may be any kind of data such as image data, video image data, text data, audio data, etc.

In FIG. 3, the processes 1 to 4 are illustrated, and the processes 1 and 2 are to be performed with the on-premise server 30 or the MFP 20, and the processes 3 and 4 are to be performed with the cloud server 70. The on-premise server 30 or the MFP 20 that performs the process 1 sends target data, which is a result of the process 1 to one of the on-premise server 30 and the MFP 20 that is to perform the process 2 next. The on-premise server 30 or the MFP 20 transmits the target data to the cloud server 70 when the process 2 is completed. The cloud server 70 performs the process 4 after completing the process 3.

The workflow information 9 may or may not define the information processing device as a device that executes processing for each process in advance. For example, a case where the information processing device is defined as a device that executes processing in advance is described below. When the cloud server 70, the on-premise server 30, and the MFP 20 perform a plurality of processes by cooperating with each other, the workflow information 9 defines which one of the cloud server 70, the on-premise server 30, and the MFP 20 performs each process.

When each information processing device performing one of the plurality of processes according to the workflow information 9 is changed from the former process, the target data that is a result of a former process is transmitted, for example, from the first information processing device, which is the device that executes processing of the former process, to the second information processing device that is the device that executes processing of the subsequent process. For example, when the device that executes processing is changed from the on-premise server 30 to the cloud server 70 in a workflow, the on-premise server 30 passes the target data (results of the former process) to the cloud server 70 through the network 40 and the Internet N. On the other hand, when the device that executes processing is changed from the cloud server 70 to the on-premise server, flow of the target data is reversed, from the cloud server 70 to the on-premise server 30.

This allows the on-premise server 30 and the cloud server 70 execute the plurality of processes defined in the workflow information 9 by cooperating with each other.

The workflow information 9 is described in a data format that is interpretable by a computer. The workflow information 9 is described with, for example, Extensible Markup Language (XML).

A case where a device that executes processing is not defined in advance is described below. When the device that executes processing is not defined in advance, the on-premise server 30 refers to the table in which each process and the one or more information processing devices (MFP 20, client terminal 21, portable terminal 22) that can perform the process are registered in association with each other, and determines one of the information processing device to which the target data, which is a result of the former process, is transmitted. When the information processing device is in the cloud, the target data is transmitted to the cloud server 70. Similarly, the cloud server 70 refers to the table, in which each process and each information processing device are registered in association with each other, and determines one of the information processing device to which the target data is transmitted.

When the firewall 50 has information indicating that the target data is transmitted from the on-premise server 30 to the cloud server 70, the firewall 50 lets the target data pass from the cloud server 70 to the on-premise server 30 by regarding the target data as a response to the on-premise server 30 in response to the transmission form the on-premise server 30 to the cloud server 70.

Alternatively, by storing the target data in the cloud server 70 or the cloud workflow management server 71 by the cloud server 70, the on-premise server 30 can perform the post process by retrieving the target data from the cloud server 70 or the cloud workflow management server 71.

### <Hardware Configuration>

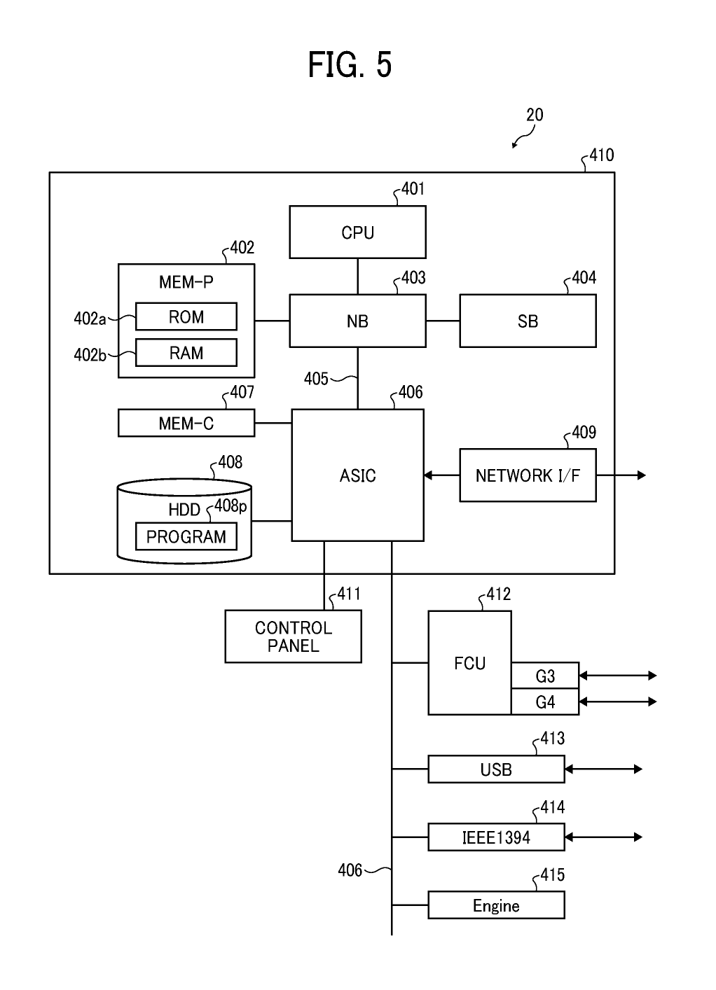

FIG. 4 is a block diagram illustrating an example of a hardware configuration of each of the on-premise server 30, the cloud server 70, the cloud workflow management server 71, and the administrator terminal 32. In the following description, the hardware configuration is described as that of the on-premise server 30. The on-premise server 30 includes a central processing unit (CPU) 301, a Read Only Memory (ROM) 302, a Random Access Memory (RAM) 303, a hard disc drive (HDD) 304, a graphic board 305 connected to a display 320, an input device 306, a media drive 307, and a network communication device 308. The CPU 301, the ROM 302, the RAM 303, the HDD 304, the graphic board 305, the input device 306, the media drive 307, and the network communication device 308 are connected to each other through a bus 310.

The CPU 301 executes a program stored in the HDD 304 using the RAM 303 as a work area to cause each component to input/output data or process the data. The ROM 302 stores a start program to read a Basic Input/Output System (BIOS) and a bootstrap loader from the HDD 304 to the RAM 303. The bootstrap loader reads an operating system (OS) from the HDD 304 to the RAM 303.

The HDD 304 is a nonvolatile memory such as a Solid State Drive (SSD). The HDD 304 stores an OS and a device driver. The HDD 304 further stores a workflow processing program. The HDD 304 also stores various types of plugin programs. These programs are distributed by being stored in a computer-readable recording medium in an installable or executable format. Alternatively, these programs may be distributed by being downloaded from a server.

The display 320 displays a graphical user interface (GUI) screen generated with the graphic board 305 with an instruction obtained by executing a program. The input device 306 includes, for example, a keyboard and a mouse, and receives a user input. The media drive 307 reads or writes data from or to an optical media such as a Digital Versatile Disk (DVD) and/or a blue lay disk. The media drive 307 reads or writes data from or to a memory card such as a flash memory. The network communication device 308 is an Ethernet (registered trademark) card that is for connecting to, for example, a LAN.

Each of the client terminal 21 and the portable terminal 22 has substantially the same hardware configuration as that of FIG. 4. Even if it has a different hardware configuration, the difference does not effect to a range of the description of the embodiment.

### <Hardware Configuration of MFP>

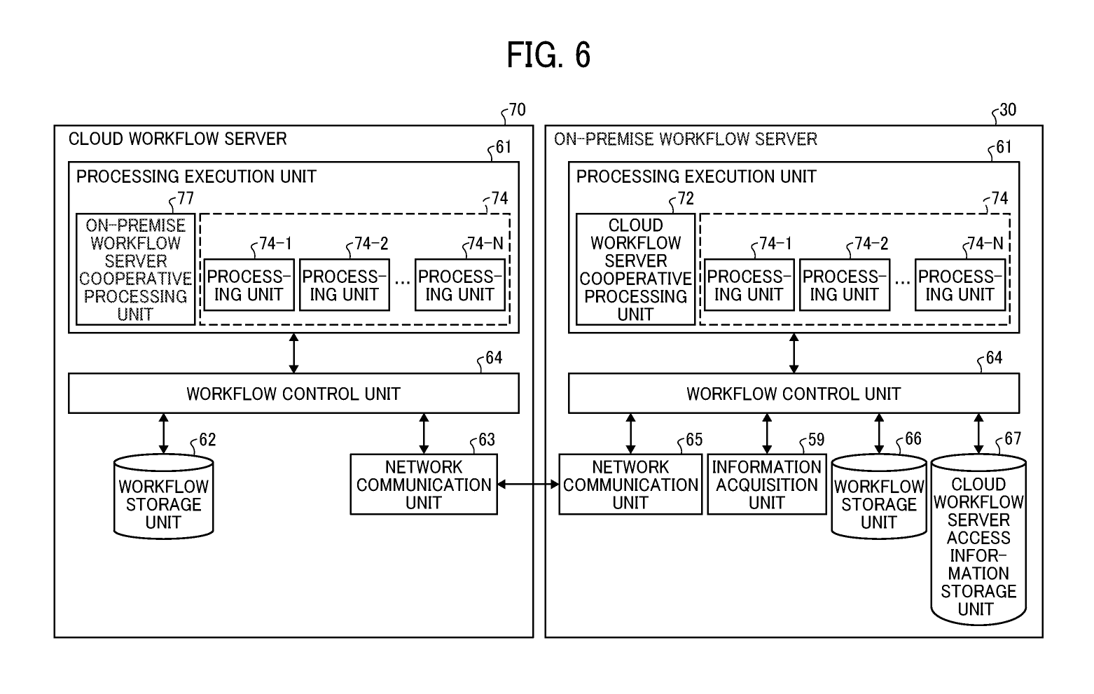

FIG. 5 is a block diagram schematically illustrating a hardware configuration of the MFP 20. The MFP 20 includes a controller 410 and an engine 415 that are connected to each other through a Peripheral Component Internet (PCI) bus 416.

The controller 410 controls overall operation of the MFP 20, such as drawing and communicating, and also controls inputs from a control panel 411. The engine 415 is, for example, a printer engine that is connectable to the PCI bus 416, and includes a white black plotter, a one-drum color plotter, a four-drum color plotter, a scanner, and a fax unit.

The engine 415 also includes an image processing section that performs image processing such as error diffusion and gamma conversion, in addition to an engine section such as a plotter.

The controller 410 includes a CPU 401, a north bridge (NB) 403, a system memory (MEM-P) 402, a south bridge (SB) 404, a local memory (MEM-C) 407, an Application Specific Integrated Circuit (ASIC) 406, and an HDD 408, and the NB 403 and the ASIC 406 are connected to each other through an Accelerated Graphics Port (AGP) bus 405.

Additionally the MEM-P 402 further includes a ROM 402a and a RAM 402b.

The CPU 401 controls overall operation of the MFP 20, and includes a chip set including the NB 403, the MEM-P 402, and the SB 404. The chip set described above connects to other chips.

The NB 403 is a bridge that connects among the CPU 401, the MEM-P 402, the SB 404, and the AGP bus 405, and includes a memory controller that reads from or writes to the MEM-P 402 and a Peripheral Component Interconnect (PCI) master, and an AGP target.

The MEM-P 402 is a system memory that is used as, for example, a memory storing a program and data, a working memory for a program or data, or a memory for drawing with a printer, and includes the ROM 402 and the RAM 402b.

The ROM 402a, which only can read, is used for storing a program and data, and the RAM 402, which can read and write, is used as a working memory for the program and the data or used as a drawing memory used with the printer.

The SB 404 is a bridge that connects the NB 403 to a PCI device and a peripheral device. The SB 404 is also connected to the NB 403 through a PCI bus, and the PCI is also connected to a network interface (I/F) 409. The ASIC 406 is an Integrated Circuit (IC) that has a hardware element for image processing. The ASIC 406 serves as a bridge that connects the AGP bus 405, the PCI bus 416, the HDD 408, and the MEM-C 407 to each other.

The ASIC 406 includes a PCI target, an AGP master, an arbiter (ARB), which is a core or the ASIC 406, a memory controller that controls the MEM-C 407, a plurality of direct memory access controllers (DMACs) capable of rotating image data with a hardware logic, and a PCI unit that transfers data with the engine 415 through the PCI bus.

The network I/F 409 is a communication device, such as a Network Interface Card (NIC), to communicate with the cloud server 70 through a network.

The ASIC 406 is connected to a facsimile control unit (FCU) 412, a universal serial bus (USB) 413, and the Institute of Electrical and Electronics Engineers 1394 (IEEE 1394) interface 414 through the PCI bus.

The control panel 411 is directly connected to the ASIC 406. The MEM-C 407 is a local memory that is used as a copy image buffer or a code buffer. The HDD 408 is a storage that stores image data, a program, font data, and a form.

The HDD 408 saves a license file of an application executed with the MFP 20. The AGP bus 405 is a bus interface for a graphics accelerator card that is devised for accelerating graphic processing, and accelerates the graphics accelerator card by directly accessing the MEM-P 402 with high throughput.

### <Functions>

Functions of the on-premise server 30, the cloud server 70, the cloud workflow management server 71, the administrator terminal 32, and the MFP 20 are described below.

### <<On-premise Server 30, Cloud Server 70>>

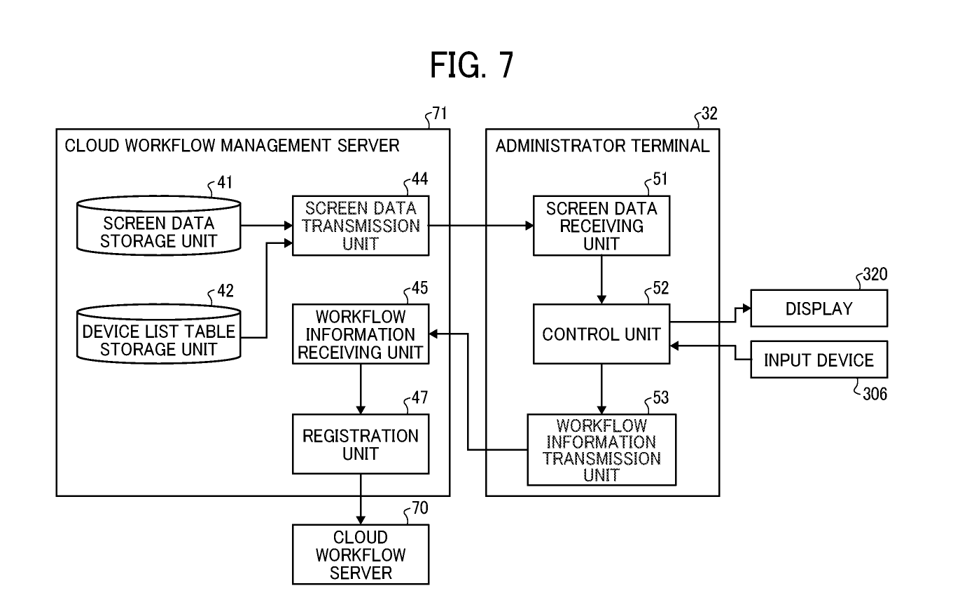

FIG. 6 is a block diagram illustrating one example of a functional configuration of the on-premise server 30 and the cloud server 70. The cloud server 70 includes a processing execution unit 61, a network communication unit 63, and a workflow control unit 64. These components are implemented as functions or means with instructions output from the CPU 301 as illustrated in FIG. 4 according to a program 304p. The cloud server 70 also includes a workflow storage unit 62. The workflow storage unit 62 is configured as the HDD 304 or the RAM 303 illustrated in FIG. 4, and stores the workflow information 9, at least one piece of definition information, that is registered from the cloud workflow management server 71.

The processing execution unit 61 performs each of the plurality of processes defined in the workflow information 9. The processing execution unit 61 includes an on-premise workflow server cooperative processing unit 77 and a plurality of processing units 74 (74-1, 74-2, . . . , 74-N) (N is an integer number). Hereinafter, the plurality of processing units 74 may be collectively referred to as processing units 74, and any single processing unit may be referred to as a processing unit 74. Each of the plurality of processing units 74 performs a process that is different from other processes performed with the other processing units 74. Each of the plurality of processing units 74 is implemented by a corresponding plugin program that is called with the workflow control unit 64 and executed by the CPU 301.

For example, the processing execution unit 61 registers a plugin program for optical character recognition (OCR), which may be referred to as an OCR plugin program, in advance, and the OCR plugin program is called and executed for the OCR. Additionally, the processing execution unit 61 registers, for example, another plugin program for mail delivery, which may be referred to as a mail delivery plugin program, and the mail delivery plugin program is called and executed for the mail delivery.

One or more processing units 74 of the cloud server 70 may perform the same process as that of the on-premise server 30. For example, both the cloud server 70 and the on-premise server may include the processing unit 74 for mail delivery, and either one of them may be used for performing the process of mail delivery. Additionally, even when being able to perform the same process, the processing units 74 does not have to perform the same process (execute a common program) due to a soft configuration or a license form. Additionally, there may be a process that the only processing unit 74 of the cloud server 70 can perform and another process that the only processing unit 74 of the on-premise server 30 can perform.

The on-premise workflow server cooperative processing unit 77 requests the on-premise servers 30 to execute the workflow.

The workflow control unit 64 of the cloud server 70 requests to the processing unit 74 of the cloud server 70 for performing a process, when the process is indicated to be performed with the cloud server 70, namely when the cloud server 70 is the device that executes processing according to the workflow information 9. When the process is to be performed with the on-premise server 30, the workflow control unit 64 of the cloud server 70 requests to the on-premise server 30 using the on-premise workflow server cooperative processing unit 77.

The network communication unit 63 communicates with the on-premise server 30 through the network 80 and the Internet N for target data.

The on-premise server 30 includes the processing execution unit 61, a network communication unit 65, the workflow control unit 64, and the information acquisition unit 59. The processing execution unit 61 includes the processing units 74 and a cloud workflow server cooperative processing unit 72. The cloud workflow server cooperative processing unit 72 requests to the cloud server 70 for executing the workflow. The processing unit 74 and the cloud workflow server cooperative processing unit 72 are functions or means implemented by instructions output from the CPU 301 according to the program 304p illustrated in FIG. 4.

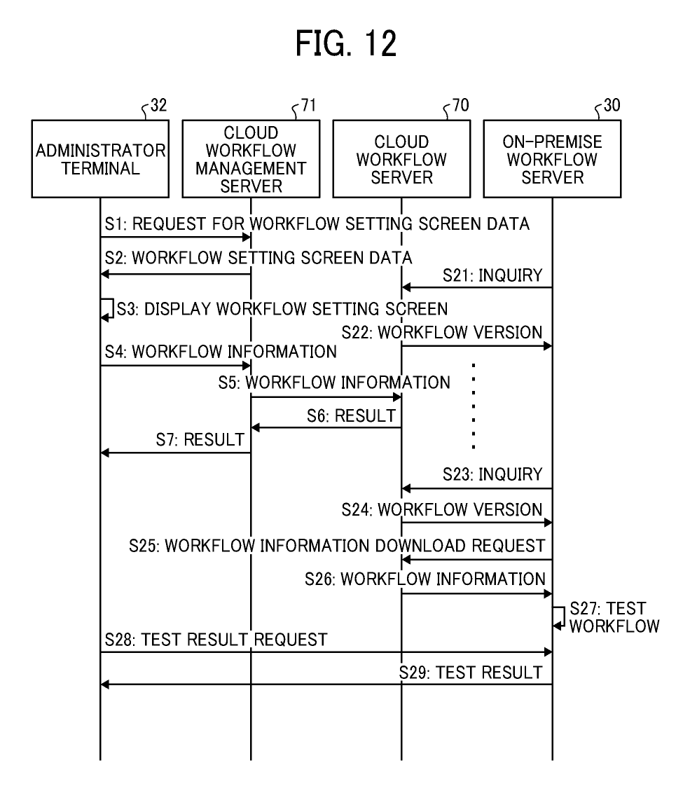

Additionally, the on-premise server 30 includes a workflow storage unit 66 and a cloud workflow server access information storage unit 67. The workflow storage unit 66 and the cloud workflow server access information storage unit 67 are storage means implemented with, for example, the HDD 304 or the RAM 303 illustrated in FIG. 4. The workflow storage unit 66 stores the workflow information 9 obtained from the workflow storage unit 62 of the cloud server 70 with the information acquisition unit 59. Storing of the workflow information 9 is described later with reference to FIG. 12.

The cloud workflow server access information storage unit 67 stores an Internet protocol (IP) address or a uniform resource locator (URL) and authentication information for communicating with the cloud server 70. The authentication information does not have to be set in advance but may be input when workflow is executed.

The information acquisition unit 59 periodically determines whether the workflow information 9 is updated or not, at a predetermined time, for example, at a fixed time or when a load is low. The information acquisition unit 59 may send inquiry for an update to the cloud server 70. When the workflow information 9 is updated, the information acquisition unit 59 acquire the workflow information from the cloud server 70, and a test run of the workflow succeeded, the workflow information 9 is stored in the workflow storage unit 66.

The network communication unit 65 communicates with the cloud server 70 for target data through the network 40 and the Internet N. The workflow control unit 64 of the on-premise server 30 requests to the processing unit 74 of the on-premise server 30 for performing a process, when the process is indicated to be performed with the on-premise server 30, namely when the on-premise server 30 is the device that executes processing according to the workflow information 9.

When the process is to be performed with the cloud server 70, the workflow control unit 64 requests to the cloud server 70 with the cloud workflow server cooperative processing unit 72. The cloud workflow server cooperative processing unit 72 obtains an IP address of the cloud server 70 from the cloud workflow server access information storage unit 67 and requests to an Web application programing interface (API) of the cloud server 70 to perform the process via the network communication unit 65. The Web API is used for ruling matters in executing processing with two or more information processing devices (for example, a method for requesting, a method for designating data, etc.) through a network, or used for connecting two or more information processing devices by communication. The Web API may be simply referred to as “Interface (IF)”.

### <<Cloud Management Server, Administrator Terminal>>

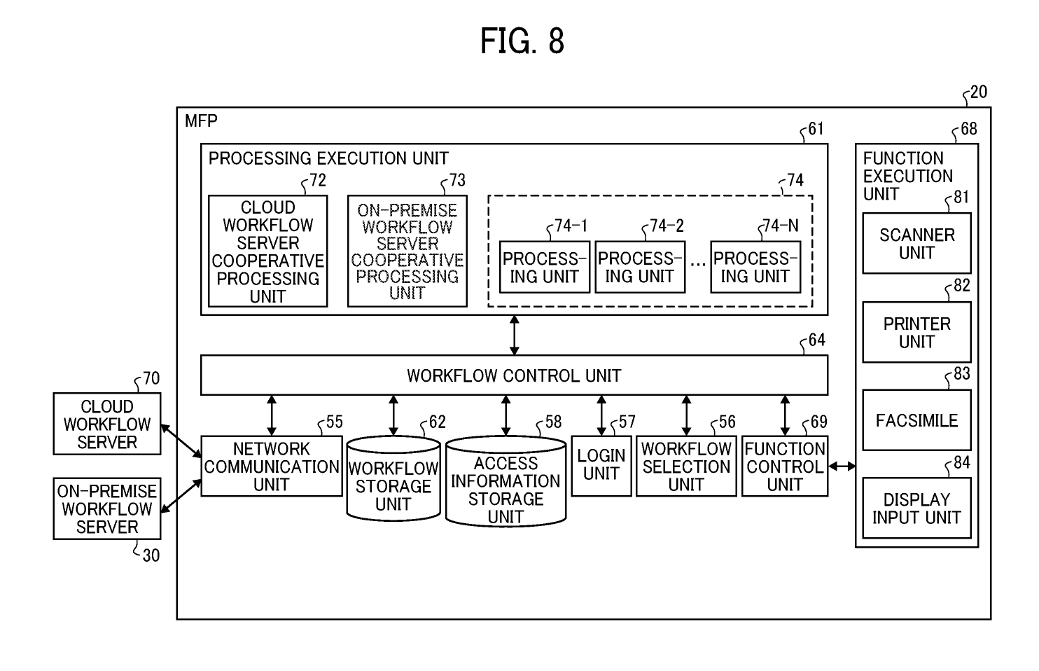

FIG. 7 is a block diagram illustrating a functional configuration of the cloud workflow management server 71 and the administrator terminal 32. The administrator terminal 32 may be any one of the administrator terminals 32A and 32B. The cloud workflow management server 71 includes a screen data transmission unit 44, a workflow information receiving unit 45, and a registration unit 47. The screen data transmission unit 44, the workflow information receiving unit 45, and the registration unit 47 are functions or means implemented by instructions output from the CPU 301 according to the program 304p illustrated in FIG. 4. The cloud workflow management server 71 includes a screen data storage unit 41 and a device list table storage unit 42. The screen data storage unit 41 and the device list table storage unit 42 are storage means implemented with, for example, the HDD 304 or the RAM 303 illustrated in FIG. 4.

The screen data storage unit 41 stores screen data to be displayed with the administrator terminal 32 when the workflow information 9 is defined. The screen data is described, for example, as HyperText Markup Language (HTML) data, with a script language, or Cascading Style Sheets (CSS). In addition to still screen data, dynamic screen data may be generated with the screen data transmission unit 44 as a Web application.

Information stored in the device list table storage unit 42 is described with reference to Table 1.

TABLE 1

| Process | Information Processing Device | Machine ID |
|---|---|---|
| document scan | MFP | 001 |
| OCR | on-premise workflow server | 002 |
| in-house system data | on-premise workflow server | 002 |
| acquisition | | |
| cloud distribution | cloud workflow server | 003 |

Table. 1 is a device list table stored in the device list table storage unit 42. The device list table registers data items such as Process, Information processing device, and Machine ID that are associated with each other. An item, Process, indicates specific contents of a process that can be defined in the workflow information 9. Another item, Information processing device, indicates one or more specific information processing devices each of which can be the execution projects for the process. Still another item, Machine ID, indicates information for identifying the information processing device. ID is an abbreviation of Identification and means an identifier or identification information. ID is one or a combination of a name, a code, a character string, and a numeral value, and used for uniquely distinguishing a specific target from a plurality of targets.

The cloud workflow management server 71 is described below. The screen data transmission unit 44 transmits the screen data stored in the screen data storage unit 41 and the device list table stored in the device list table storage unit 42 to the administrator terminal 32.

The workflow information receiving unit 45 receives the workflow information 9 defined by operation of the administrator 8 with the administrator terminal 32. The registration unit 47 sends the workflow information 9 to the cloud server 70, and the workflow information 9 is stored in the workflow storage unit 62 of the cloud server 70.

The administrator terminal 32 includes a screen data receiving unit 51, a control unit 52, and a workflow information transmission unit 53. The screen data receiving unit 51, the control unit 52, and the workflow information transmission unit 53 are functions or means implemented by instructions output from the CPU 301 according to the program 304p illustrated in FIG. 4.

The screen data receiving unit 51 receives screen data from the cloud workflow management server 71. The control unit 52 causes the display 320 to display the screen data received with the screen data receiving unit 51 while defining the workflow information 9 according to an input from the input device 306. More specifically, the control unit 52 causes the display 320 to display a screen for defining an order of the plurality of processes to be performed, and the device that executes processing for each process, namely which information processing device performs each process. The control unit 52 defines the workflow information 9, which defines an order of the plurality of processes to be performed, and the device that executes processing for each process, namely which information processing device performs each process, according to input operation on the screen.

The workflow information transmission unit 53 transmits the workflow information 9 defined with the control unit 52 to the cloud workflow management server 71.

### <<MFP>>

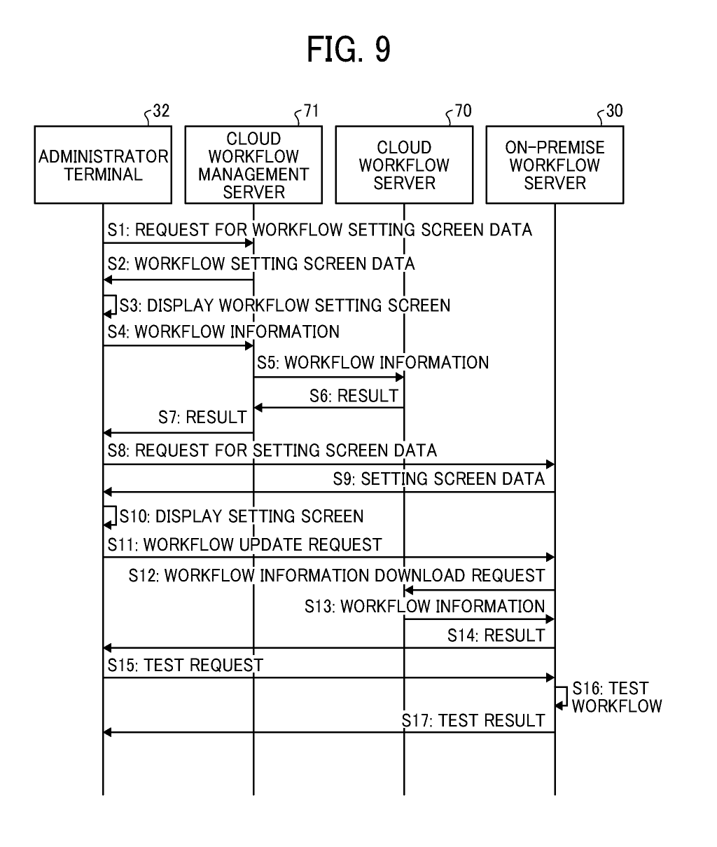

FIG. 8 is a block diagram illustrating a functional configuration of the MFP 20. The MFP 20 includes a processing execution unit 61, a network communication unit 55, a workflow control unit 64, a login unit 57, a workflow selection unit 56, a function execution unit 68, and a function control unit 69. These components described above are functions or means implemented by instructions output from the CPU 401 according to a program 408p illustrated in FIG. 5.

The MFP 20 also includes a workflow storage unit 62 and an access information storage unit 58. The workflow storage unit 62 and the access information storage unit 58 are storage means implemented with, for example, the HDD 408, a local memory (MEM-C) 407, or the MEM-P 402 of the MFP 20 of FIG. 5. The workflow storage unit 62 stores the workflow information 9 obtained from the cloud server 70. The access information storage unit 58 stores address information and authentication information of the on-premise server 30 and the cloud server 70. The address information of the on-premise server 30 may be input by the administrator 8 when the workflow information 9 is registered in the cloud workflow management server 71, or may be input with the control panel 411 of the MFP 20.

Additionally, the processing execution unit 61 and the workflow control unit 64 have substantially the same configuration as the processing execution unit 61 and the workflow control unit 64 of the cloud server 70, respectively. The processing execution unit 61, however, includes the cloud workflow server cooperative processing unit 72 and the on-premise workflow server cooperative processing unit 73. The processing unit 74 of the processing execution unit 61 of the MFP 20 may be the same as or different from that of the processing execution unit 61 of the on-premise server 30.

The cloud workflow server cooperative processing unit 72 is a processing unit that requests to the cloud server 70 to perform a process defined in the workflow. The on-premise workflow server cooperative processing unit 73 is a processing unit that requests to the on-premise server 30 to perform a process defined in the workflow.

The workflow control unit 64 uses the cloud workflow server cooperative processing unit 72 to request to the cloud server 70 for performing a process, when the process is indicated to be performed with the cloud server 70, namely the cloud server 70 is the device that executes processing of the process, according to the workflow information 9. The cloud workflow server cooperative processing unit 72 obtains an IP address of the cloud server 70 from the access information storage unit 58, and requests, via the network communication unit 55, to the Web API of the cloud server 70 to perform the process. When receiving the request to perform the process, the network communication unit 63 requests to the workflow control unit 64 for performing the process in the cloud server 70. The same applies to a case where the on-premise server 30 is the device that executes processing.

The network communication unit 55 communicates with the cloud server 70 through the network 40 and the Internet N, and the on-premise server 30 through the network 80.

The login unit 57 receives login information to log in to the MFP 20 based on user operation. The login information includes, for example, a user name and a password, information stored in an IC card, or biological information such as a fingerprint. The workflow selection unit 56 displays a list of selectable workflows and receives one of the workflows selected according to user operation.

The function execution unit 68 performs a specific function specific to the MFP 20. The specific function requires dedicated hardware. The function execution unit 68 includes, for example, a scanner unit 81, a printer unit 82, a facsimile unit 83, and a display input unit 84. The scanner unit 81 scans a sheet set on a platen and obtains image data. The printer unit 82 prints images and the like on the sheet. The facsimile unit 83 establishes communication for facsimile transmission and reception through a telephone line or the network 40. The display input unit 84 displays information to the user, and receives user input operation.

The function control unit 69 controls functions implemented by the function execution unit 68. The function control unit 69 causes the function execution unit 68 to perform a process according to a call from the workflow control unit 64 when the workflow information 9 defines the process is to be performed with the function execution unit 68.

### <Registration of Workflow>

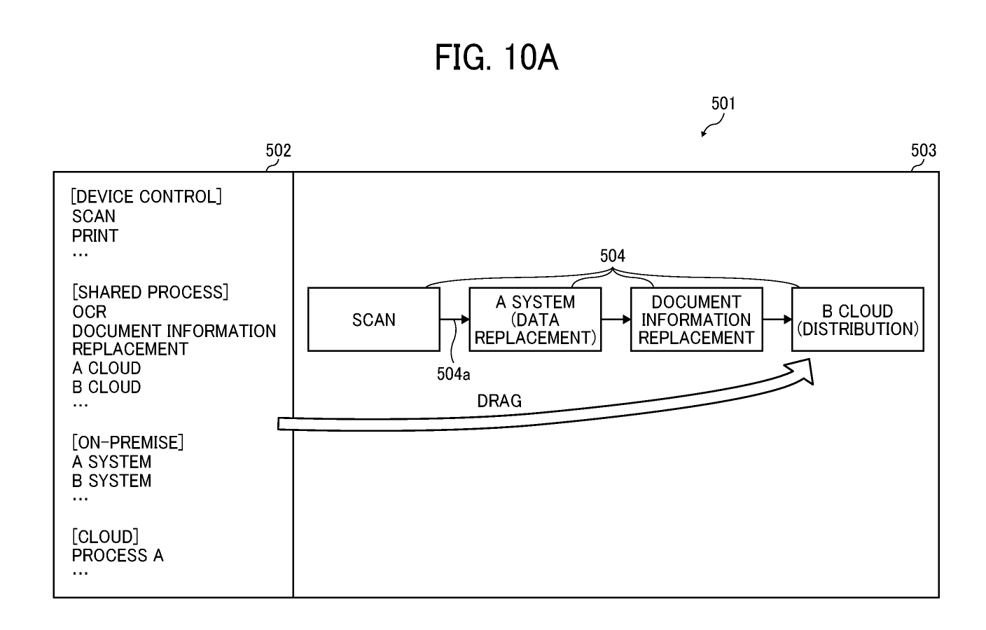

FIG. 9 is a sequence diagram illustrating operation of setting the workflow information 9 by the administrator terminal 32 operated by the administrator 8. The operation of FIG. 9 starts when the administrator terminal 32 receives a request for setting the workflow information 9 the administrator 8. The administrator terminal 32 may be connected any one of the network 40 and the network 80.

S1: The administrator terminal 32 accesses the cloud workflow management server 71 and requests screen data in relation to a workflow setting screen 501.

S2: The screen data transmission unit 44 of the cloud workflow management server 71 transmits the screen data for the workflow setting screen 501, obtained from the screen data storage unit 41, to the administrator terminal 32.

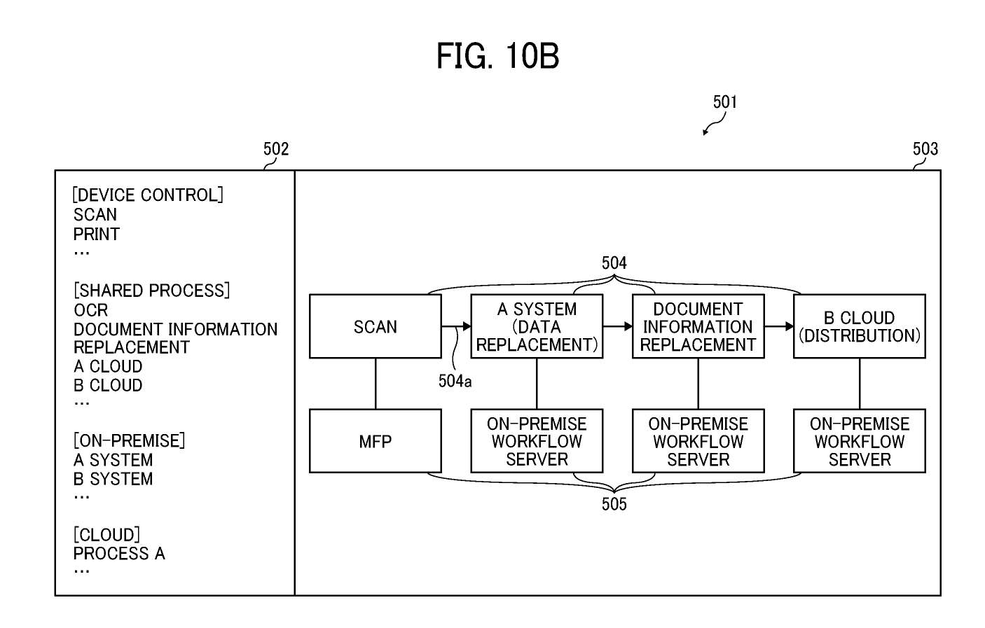

S3: The screen data receiving unit 51 of the administrator terminal 32 receives the screen data for the workflow setting screen 501, and the control unit 52 analyzes the screen data received with the screen data receiving unit 51 to display the workflow setting screen 501 on the display 320. An example screen of the workflow setting screen 501 is illustrated in FIG. 10A and FIG. 10B.

S4: After defining a workflow, the administrator 8 operates the administrator terminal 32 to register the workflow information 9 corresponding to the workflow in the cloud workflow management server 71. The administrator 8 can give any desired name to the workflow information 9, which is definition information corresponding to the workflow defined. The workflow information transmission unit 53 of the administrator terminal 32 transmits the workflow information 9 and a request for registration of the workflow information 9 (registration request) to the cloud workflow management server 71.

S5: The workflow information receiving unit 45 of the cloud workflow management server 71 receives the workflow information 9 and the registration request. Subsequently, the registration unit 47 of the cloud workflow management server 71 transfers the workflow information 9 and the registration request to the cloud server 70. When the cloud workflow management server 71 and the cloud server 70 are configured in and as the same server, this step is not necessary. The cloud server 70 stores the workflow information 9 in the workflow storage unit 62.

S6: The cloud server 70 transmits a result indicating registration of the workflow information 9 in response to the registration request in relation to the workflow information 9 to the cloud workflow management server 71.

S7: The cloud workflow management server 71 transfers the result in response to the registration request for the workflow information 9 to the administrator terminal 32.

S8: Subsequently, the administrator 8 operates the administrator terminal 32 to access the on-premise server 30 for setting the workflow information 9 in the on-premise server 30. The screen data receiving unit 51 of the administrator terminal 32 makes a request for a setting screen 511 to the on-premise server 30.

S9: The network communication unit 65 of the on-premise server 30 obtains screen data for the setting screen 511 from a storage unit, which may be implemented with the HDD 304 or the RAM 303 of FIG. 4, and transmits the screen data for the setting screen 511 to the administrator terminal 32. When the administrator terminal 32 is connected to the network 80, a virtual private network (VPN) is used for example, to clear the firewall 50.

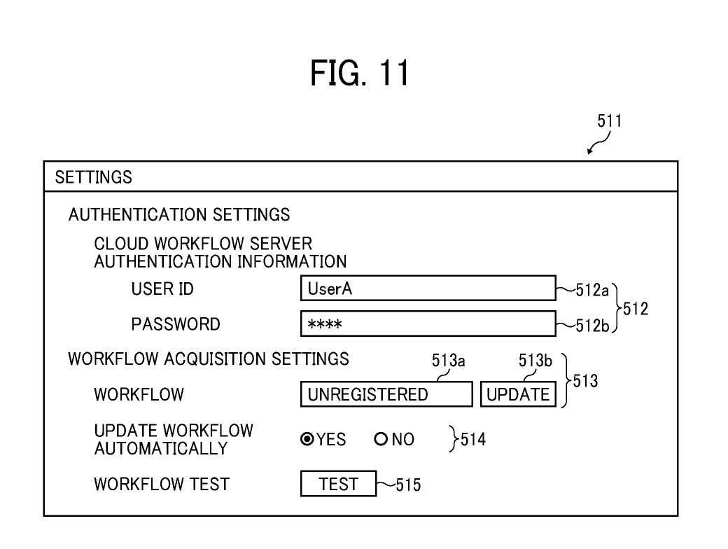

S10: The screen data receiving unit 51 of the administrator terminal 32 receives the screen data for the setting screen 511 and the control unit 52 causes the display 320 to display the setting screen 511. An example of the setting screen 511 is illustrated in FIG. 11. The setting screen 511 is a screen for setting in relation to registration of the workflow information 9. A detailed description of the setting screen 511 is deferred with reference to FIG. 11.

S11: The administrator 8 sets required items with the setting screen 511 and transmits a workflow update request by operating the administrator terminal 32. The control unit 52 of the administrator terminal 32 receives the operation by the administrator 8 and sends the workflow updated request to the on-premise server 30. The workflow updated request is a request to update the workflow information 9 stored in the on-premise server 30. In response to the workflow update request, the on-premise server 30 acquires the workflow information 9 registered in the cloud server 70 and replaces the workflow information 9 stored in the on-premise server 30 with the obtained workflow information 9.

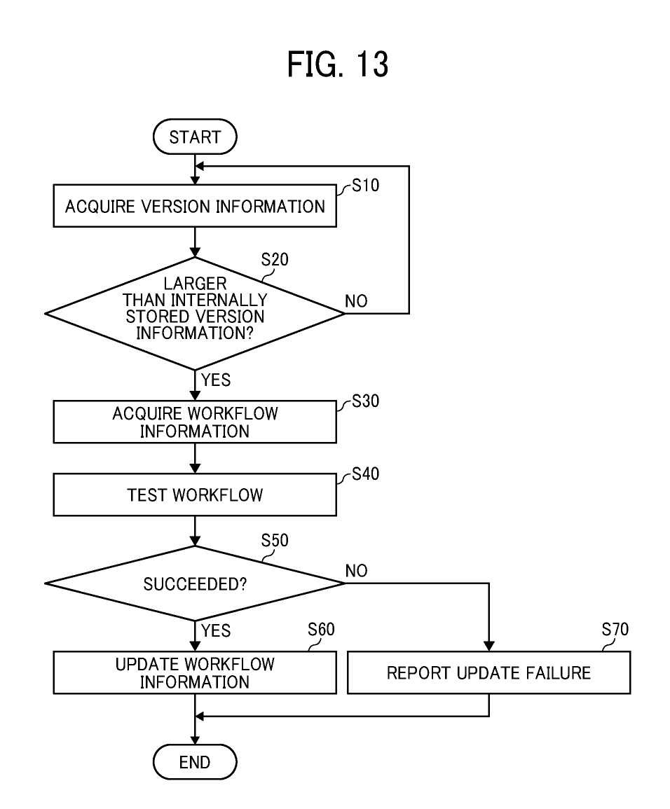

S12: The network communication unit 65 of the on-premise server 30 receives the workflow updated request and requests to the cloud server 70 for downloading the workflow information 9 with the information acquisition unit 59. A detailed description of the updating process is deferred with reference to FIG. 13.

S13: The network communication unit 63 of the cloud server 70 transmits the workflow information 9 to the on-premise server 30. A part of the workflow information 9 that is not previously transmitted, or all of the workflow information 9 may be transmitted to the on-premise server 30. The network communication unit 65 of the on-premise server 30 receives the workflow information 9 from the cloud server 70.

S14: The workflow control unit 64 of the on-premise server 30 transmits a result obtained after updating the workflow information 9 to the administrator terminal 32. That is, the workflow control unit 64 of the on-premise server 30 reports that the on-premise server 30 has successfully obtained the workflow information 9 registered by the administrator 8.

S15: The administrator 8, subsequently, performs a test run of the workflow to check whether the workflow is actually executable. The administrator terminal 32 sends a request for the test (test request) to the on-premise server 30. With the test run, each of the plurality of processes defined in the workflow information 9 is performed with the MFP 20, the on-premise server 30, or the cloud server 70 to check whether the entire workflow is appropriately executed. Regarding a process that requires cooperation with other system to be performed, a connection test is performed to check if communication with the other system is appropriately established.

S16: The workflow control unit 64 of the on-premise server 30 executes the workflow based on the workflow information 9. Additionally, the workflow control unit 64 of the on-premise server 30 performs a process to which the on-premise server 30 is defined as a device that executes processing and requests to the cloud server 70 to perform other process to which the cloud server 70 is defined as a device that executes processing. When requesting to the cloud server 70 to perform the process and the process is performed, the on-premise server 30 obtains target data or a result of the process from the cloud server 70.

S17: The workflow control unit 64 of the on-premise server 30 transmits a test result to the administrator terminal 32 via the network communication unit 65.

By performing the test run as described above, the administrator 8 determines the workflow information 9 is appropriate or not. When a workflow that is executed by the cloud server 70 by cooperating with a system in the on-premise is set as the workflow information 9 by the administrator 8, there may be an inappropriate case. For example, in a case of the workflow information 9 indicating processing of delivering data to a shared folder in the on-premise, the cloud server 70 is not able to replicate a path to the shared folder in the system in the on-premise with the workflow setting screen 501. Even if the path can be replicated, there is still possibility of a case that the pass in the on-premise is changed. In this case, the administrator 8 may input the pass, which is obtained and wrong. To deal with this case, performing a test to check whether the pass is actually available is helpful.

As described in FIG. 9, the administrator 8 can register the workflow information 9 even when the administrator 8 has no way to connect to the network 40 in the on-premise, for example, when the administrator 8 is visiting outside of the site of on-premise, by using the cloud workflow management server 71. Additionally, even when there are the plurality of the on-premise servers 30 operating in the on-premise, the administrator 8 can register or update the workflow information 9 in each of the plurality of the on-premise servers 30 by simply registering or updating the workflow information 9 in the cloud workflow management server 71, resulting in reduction of an amount of work corresponding to the number of the on-premise servers 30.

### <<Workflow Setting Screen>>

FIG. 10A and FIG. 10B are examples of the workflow setting screen 501. FIG. 10A illustrates in a case where the device that executes processing is not defined, and FIG. 10B illustrates in a case where the device that executes processing is defined.

The workflow setting screen 501 includes a process list section 502 and a workflow edition section 503. The process list section 502 displays a list of processes selectable in a workflow. The workflow edition section 503 is a section used by the administrator 8 for editing the contents of a series of the plurality of processes 504, an order of the plurality of processes to be perfumed, and one or more information processing devices as devices that execute processing.

The administrator 8 selects a specific process displayed in the process list section 502 with the input device 306, such as a mouse, and drags the selected process to the workflow edition section 503 to designate the process included in the workflow. The administrator 8 defines the workflow by dragging two or more processes to be performed in the workflow from the process list section 502. In FIG. 10A and 10B, an order of the processes is indicated with an arrow 504a. Additionally, the administrator 8 can change the order of the processes in the workflow by changing a position of each process that is previously dragged to the workflow edition section 503.

In FIG. 10A, the workflow is defined in a manner that “scan”, “A system (data acquisition)”, “document information replacement” and “B cloud (distribution)” are performed in this order. The workflow indicates that the MFP 20 scans a document and generates image data, obtains the data from the A system and use the data for distributing to the B cloud.

With the workflow setting screen 501 of FIG. 10B, the administrator 8 can select one of the devices that execute processing (devices) 505 for each process in the workflow. Administrator 8 can select the device that executes processing for each process. More specifically, one of the MFP 20, the on-premise server 30 and the cloud server 70 is selected for corresponding one of the processes. Table 1 stores the correspondence relationship between a process and an information processing device.

Instead of determining according to the preference set by the administrator 8, the administrator terminal 32 may automatically determine a device that executes processing corresponding to a process to which the device that executes processing is limited. For example, scan can be performed only by the MFP 20 and data acquisition from the A system can be performed only by the on-premise server 30, the administrator terminal 32 sets the MFP 20 as the device that executes processing for the scan and the on-premise server 30 as the device that executes processing for the data acquisition from the A system. When there is one information processing device that can perform a process selected by the administrator 8, the control unit 52 of the administrator terminal 32 sets the information processing device to the device that executes processing for the process selected by the administrator 8. At this time, a correspondence relationship between the process and the device that executes processing is not to be changed so that the control unit 52 of the administrator terminal 32 preferably configures the workflow-setting screen 501 in a manner that the administrator 8 cannot change.

On the other hand, because the cloud server 70 and the on-premise server 30 use shared processing unit 74 so that there is a process that can be performed either one of the on-premise server 30 and the cloud server 70. For example, the process of distributing to the B cloud in FIG. 10B is defined to be performed by the on-premise server 30, but the cloud server 70 also can perform the process. The administrator 8, accordingly, can also define the cloud server 70 to perform the process. For example, when the administrator 8 does not desire to connect to the on-premise, namely desires only to connect to the cloud, which is a distribution destination of the data, the administrator 8 can change the device that executes processing to the cloud server 70.

### <<Setting Screen>>

FIG. 11 is an illustration of an example of the setting screen 511. The setting screen 511 includes an authentication information section 512, a workflow acquisition section 513, a workflow automatic-update setting section 514, and a test execution button 515. The authentication information section 512 further includes a user ID section 512a and a password section 512b. The user ID section 512a is an area where an ID of the administrator 8 is to be input and the password section 512b is a space where a password of the administrator 8 is to be input. The user ID and the password are required when the on-premise server 30 accesses the cloud server 70. The access control device 60 authenticates the user (or on-premise server 30) based on the user ID and the password, and the authentication allows the on-premise server 30 to communicate with the cloud server 70.

The workflow acquisition section 513 is a section to display a name of the workflow information 9 registered in the on-premise server 30. The workflow acquisition section 513 includes a name section 513a and an update button 513b. The name section 513a is a blank (“unrequested” is displayed in FIG. 11) in the initial state. When the administrator 8 presses the update button 513b, the administrator terminal 32 receives this operation and obtains the name of the workflow information 9 that is obtained from the cloud server 70 by the on-premise server 30. The name obtained at this time may be a name of the latest workflow information 9 or all names of the workflow information 9 that are registered by the administrator 8. The name of the workflow information 9 obtained by the on-premise server 30 is sent to the administrator terminal 32 and displayed in the name section 513a. That is, when the update button 513b is pressed in S10 of FIG. 9, the name of the workflow information 9 set in S3 is displayed in the name section 513a.

The workflow automatic-update setting section 514 is a section to be used to set, by the administrator 8, whether the on-premise server 30 automatically update the workflow information 9. In automatically updating the workflow information 9, the on-premise server 30 automatically acquires the workflow information 9 from the cloud server 70 without operation by the administrator 8 as illustrated in S11 of FIG. 9. An operation sequence of automatically updating is deferred with reference to FIG. 12.

The test execution button 515 is a button to execute a workflow test according to the workflow information 9 registered by the administrator 8. In S15 of FIG. 9, the administrator 8 presses the test execution button 515.

### <<Automatic Update of Workflow Information 9>>

FIG. 12 is a sequence diagram illustrating operation of automatically updating the workflow information 9 set by the administrator 8 with on-premise server 30. A setting, “YES”, with the workflow automatic-update setting section 514 of FIG. 11 is sent to the on-premise server 30. In a description regarding FIG. 12 is focused on differences from FIG. 9. The processing from S1 to S7 is substantially the same as FIG. 9.

S21: The information acquisition unit 59 of the on-premise server 30 sends an inquiry for version information of the workflow information 9 to the cloud server 70 at a predetermined timing based on the setting, “YES”, with the workflow automatic-update setting section 514.

S22: The workflow control unit 64 of the cloud server 70 sends a response of workflow version. Determination for updating the workflow information 9 using the workflow version is described later with reference to FIG. 13.

S23: The information acquisition unit 59 of the on-premise server 30, similarly, sends an inquiry for version information of the workflow information 9 to the cloud server 70.

S24: The workflow control unit 64 of the cloud server 70 sends the workflow version as a response, however, the on-premise server 30 can detect the update because the administrator 8 registers the workflow information 9 to the cloud server 70.

S25 to S27: Through this, the on-premise server 30 obtains the workflow information 9 from the cloud server 70 in similar way to the operation in FIG. 9 and test the workflow.

S28: The administrator 8 accesses the on-premise server 30 at any timing by operating the administrator terminal 32. The administrator terminal 32 receives the operation of the administrator 8 and requests a test result.

S29: The on-premise server 30 sends the test result to the administrator terminal 32. This allows the on-premise server 30 to automatically test the workflow information 9 set by the administrator 8, and the administrator 8 can obtain the test result at any desired time.

FIG. 13 is a flowchart illustrating an example of operation of determining whether there is update of the workflow information 9 by the on-premise server 30. Table 2 illustrates version information of the workflow information 9.

TABLE 2

| Workflow name | Workflow ID | Version |
|---|---|---|
| workflow A | E601A1C0-4C90-425c-AB6F-E3E550D57300 | 0010 |
| workflow B | 084823AF-0AD1-4bfd-AC78-4707716373E3 | 0001 |
| workflow C | 4384A91F-D533-4a8c-A801-EFA66AB2FAB6 | 0005 |
| workflow D | 779F03CA-27C0-4043-8002-B43B6A1B9357 | 0023 |

The workflow information 9 includes items such as Workflow name, Workflow ID, and Version associated with each other. Workflow name is a name of the workflow information 9 set by the administrator 8. Workflow ID is information to identify the workflow information 9. Version indicates the number of revises of the workflow information 9 or a version of the workflow information 9. Version increases each time the workflow information 9 is revised. A range of increase of the version may be automatically set or set by the administrator 8. For example, Workflow A has Version 0010 that indicates the workflow information of Workflow A is revised 10 times at a maximum.

A process in FIG. 13 is described. The information acquisition unit 59 of the on-premise server 30 obtains the version information of the workflow information 9 from the cloud server 70 (S10). As described above, the information acquisition unit 59 obtains the version information of the workflow information 9 periodically based on the setting, “YES”, with the workflow automatic-update setting section 514.

The information acquisition unit 59 reads the version information of the workflow information 9 stored in the workflow storage unit 66 and determines whether a version number indicated with the obtained version information is larger or less than a currently stored version for each workflow ID (S20).

When the version information is the same as that of the workflow stored (S20: NO), S10 is repeated. More preferably, not only the version information but also whether a workflow name or a workflow ID that is not held in the on-premise server 30 is checked.

When the obtained version information is larger than the stored version information (S20: YES), the information acquisition unit 59 of the on-premise server 30 obtains the workflow information 9 from the cloud server 70 (S30).

When the on-premise server 30 obtains the workflow information 9, the workflow control unit 64 executes a test for the workflow according to the obtained workflow information 9 (S40). The administrator 8 generally is not able to check whether the process performed in the on-premise is appropriately registered or not because the registration of the workflow information 9 is performed under the cloud environment. Because there may be a case where the workflow may fail to be executed, the information acquisition unit 59 updates when passing the test of the workflow. This can prevent an error occurring after the update.

The information acquisition unit 59 determines whether the test is succeeded or not (S50)

When the test execution is succeeded, (S50: YES), the information acquisition unit 59 updates the workflow information 9 stored in the workflow storage unit 66 with the obtained workflow information 9 (S60).

When the test is not succeeded, (S50: NO), the information acquisition unit 59 reports the failure of the test to the administrator 8 (S70). Alternatively, an update process may be performed instead of executing the test. This is because there is a case where a test is not required, for example, when a system in the cloud side completes the workflow.

As described above, the on-premise server 30 automatically updates the workflow information 9 so that the workflow can collectively be updated when there are the plurality of on-premise servers 30. Additionally, the administrator 8 can register the workflow information 9 from the cloud side, resulting in convenience and maintenance.

### <Operation of Executing Workflow>

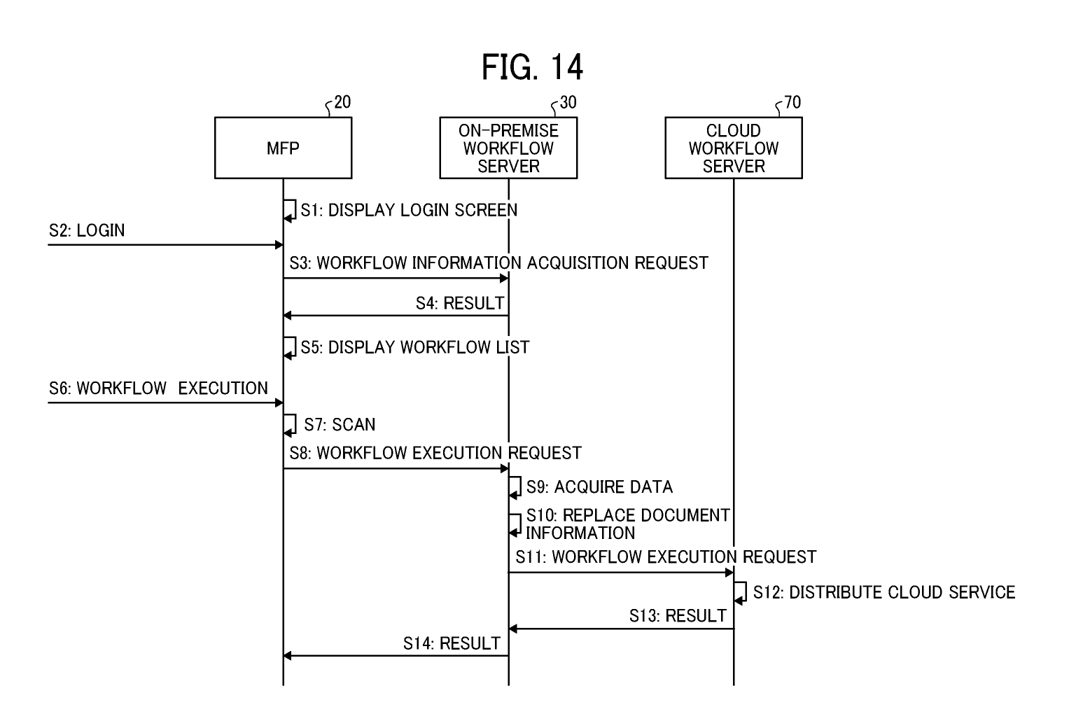

FIG. 14 is a sequence diagram illustrating example operation of executing workflow processing with the workflow system 100.

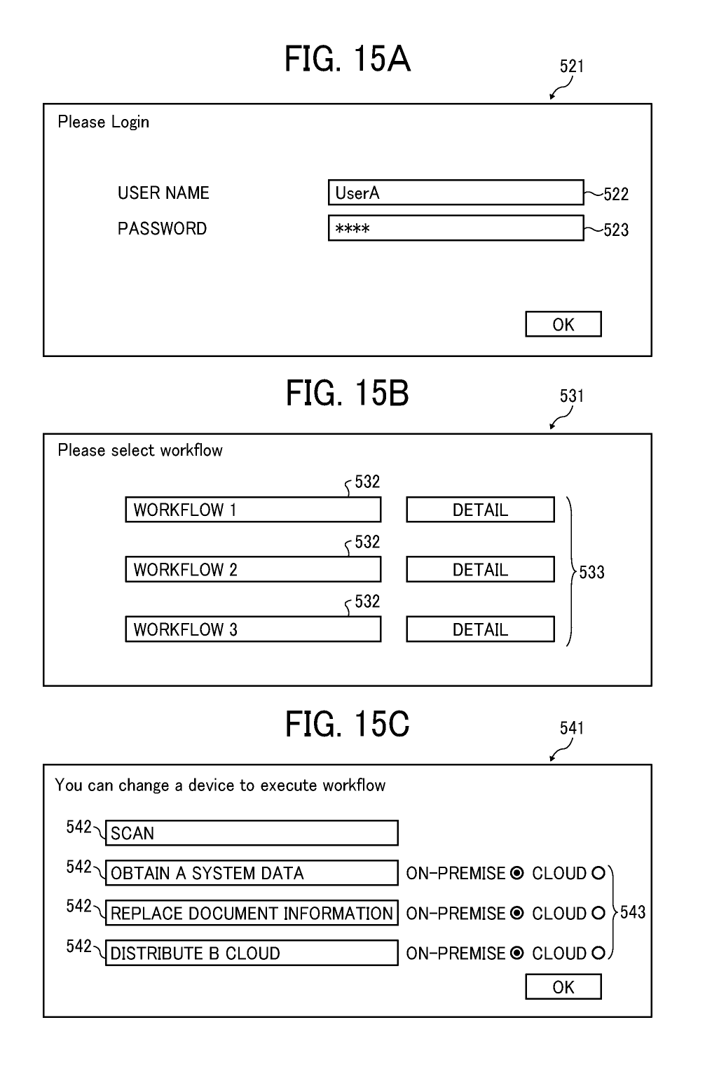

S1: A user operates the MFP 20 and causes the MFP 20 to display a login screen. The login unit 57 of the MFP 20 receives operation of the user and causes the control panel 411 to display the login screen. FIG. 15A is an illustration of an example of the login screen. The user may operates other information processing device (client terminal 21 or portable terminal 22) than the MFP 20.

S2: The user logs in to the MFP 20 by inputting a user ID and a password.

S3: In response to the login, the network communication unit 55 of the MFP 20 transmits an acquisition request for the workflow information 9 to the on-premise server 30.

S4: The on-premise server 30 transmits a list of workflow information 9 to the MFP 20.

S5: The network communication unit 55 of the MFP 20 receives the list, and the workflow selection unit 56 causes the control panel 411 to display the list of workflow information 9, a list screen 531. FIG. 15B is an illustration of an example of the list screen 531.

S6: The user selects a workflow from the plurality of workflows in the list of the workflow information 9 displayed on the control panel 411, and, for example, presses an execution button. The workflow selection unit 56 receives the selected workflow and an instruction of starting executing the workflow processing.

S7: The workflow selection unit 56 of the MFP 20 starts executing the workflow .based on the selected workflow information 9. A process as defined to be a first process, “scan”, is performed by the MFP 20 that is defined as a device that executes processing for “scan”.

S8: The on-premise server 30 is designated as a device that executes processing to perform a subsequent process that is a process of obtaining data from the A system, so that the workflow control unit 64 requests to the on-premise server 30 to execute the workflow, namely sends a workflow execution request. The workflow control unit 64 sends the workflow information 9 and target data to the on-premise server 30.

S9: The on-premise server 30 obtains the workflow information 9 and the target data, and the workflow control unit 64 performs the process that is to be performed thereby. The workflow control unit 64 obtains the data from the A system, according to a second process defined in the workflow information 9, which is “obtaining data from A system”.

S10: Subsequently, the workflow control unit 64 performs a third process defined in the workflow information 9. The third process is “Replacing Document Information”, so that the workflow control unit 64 performs document information replacement. That is, a file name of scanned image data is replaced with the data obtained from the A System.

S11: The workflow information 9 defines “Distribution on the B cloud” as a fourth process and a device that executes processing for the fourth process is a cloud server 70 so that the workflow control unit 64 transmits a workflow execution request (workflow information 9 and target data) to the cloud server 70.

S12: The workflow control unit 64 of the cloud server 70 receives the workflow information 9 and the target data from the on-premise server 30 and performs cloud distribution.

S13: The workflow control unit 64 of the cloud server 70 transmits a result obtained by performing the process to the on-premise server 30.

S14: The workflow control unit 64 of the on-premise server 30 transfers the result obtained by performing the process to the MFP 20.

In S13, the cloud server 70 sends the result as a response, and when there are one or more subsequent processes in the workflow information 9, the on-premise workflow server cooperative processing unit 77 determines a next device that executes processing by analyzing the workflow information 9 and requests to the next device that executes processing for performing a subsequent process. When the device that executes processing is in the cloud, the request is sent to the processing unit 74 of the cloud server 70, and when the device that executes processing is in the on-premise, the request is sent to the processing unit 74 of the on-premise server 30.

As described above, the workflow system 100 according to the embodiment, executes the workflow by both the on-premise and the cloud cooperating with each other.

Conventionally, when the administrator 8 defines the workflow information 9 to be executed with the cloud server 70, the workflow failed to be executed by cooperating with the system in the on-premise. According to the embodiment, the on-premise server 30 can have the same workflow information 9 that is registered in the cloud server 70 according to the user preference or automatically acquiring the workflow information 9. Furthermore, both the cloud server 70 and the on-premise server 30 has the same workflow control unit 64 and the processing unit 74 so that the processes to be performed can be divided therebetween according to the workflow information 9 common thereto, resulting in execution of the workflow by cooperating with each other.

Additionally, in a conventional embodiment, when only the on-premise server 30 executes a workflow, a program in the on-premise server 30, for, for example, distribution process with the cloud service is required to be update by, for example, a developer, each time the Web API of the cloud service is changed, resulting in poor maintenance. This update is required by the number of the on-premise servers 30, when there are the plurality of the on-premise servers 30. According to the embodiments, data acquisition or distribution process in the cloud service is performed by the cloud server 70. Accordingly, when the Web API in the cloud service is changed, the service becomes available by updating a program in the cloud server 70 without updating a program in the on-premise server 30, resulting in improvement of maintenance.

<Designating Device that Executes Processing in Executing Workflow>

In the description above of the workflow setting screen 501 of FIG. 10, the administrator 8 sets the devices that execute processing in setting the workflow, however, the embodiment is not limited to this and alternatively a user can design or set the devices that execute processing for the workflow in executing the workflow.

FIG. 15A, FIG. 15B, and FIG. 15C are illustrations of examples of a screen to be displayed on, for example, the control panel 411 of the MFP 20 when the workflow processing is executed.

FIG. 15A is an illustration of an example of a login screen 521 in execution of the workflow. The login screen 521 has a user name input section 522 and a password input section 523. Any input may be available as long as the input identify a user. When a workflow is assigned for each organization, the login screen 521 may include an input section for an organization code. The organization, here, includes a department, a group, and a division to which the user belong.

FIG. 15B is an illustration of an example of the list screen 531 of the workflows. The list screen 531 includes a workflow name 532 and a detail button 533 displaying a detail of each workflow. When the detail button 533 is pressed, the workflow selection unit 56 of the MFP 20 causes the control panel 411 to display a device change screen 541 as described in FIG. 15C.

FIG. 15C is an illustration of an example of the device change screen 541. The device change screen 541 includes a selection button 543 to select one of the on-premise server 30 and the cloud server 70 as a device that executes processing for a process 542 included in the workflow. The administrator 8 can select one of the on-premise server 30 and the cloud server 70 a device that executes processing for each process. Regarding a process, Scan 542, is only executable with the MFP 20, so that the control unit 52 of the administrator terminal 32 does not display other device that executes processing to be selected. Not displaying the other devices that execute processing to be selected can prevent the user from wrongly selecting one of the other devices that execute processing.

When the device that executes processing for a process is changed, the device that executes processing is different from the device that executes processing for the process defined in the workflow information 9. To cope with this situation, the workflow control unit 64 of the MFP 20 transmits to the on-premise server 30 information indicating which one of the on-premise server and the cloud server 70 is selected by the user (for example, a machine ID of the on-premise server 30 or the cloud server 70), when the MFP 20 requests to the on-premise server 30 for the execution of the process (S8 of FIG. 14). The workflow control unit 64 of the on-premise server 30 executes the workflow with the device that executes processing, either one of the on-premise server 30 or the cloud server 70, selected by the user in priority to the device that executes processing that is defined in the workflow information 9. Here, the device that executes processing is set when executing the workflow has not been tested, so that it may fail to perform the process. In this case, the process of the workflow is performed with the device that executes processing defined in the workflow information 9. It is further preferable if the MFP 20 is able to set whether or not to execute the workflow with the device that executes processing defined in the workflow information 9 with the MFP 20, in a case where the device that executes processing set in executing the workflow fails to perform the process.

Enabling to change the device that executes processing in executing the workflow by the user, the workflow can be executed with the cloud server 70, in a case, for example, where the on-premise server 30 is offline. Additionally, executing the workflow with the on-premise server 30 by the user according to a level of security required for a document to be scanned can reduce security risk, such as information leakage.

### <Other Example for Application>

The present disclosure is not limited to the details of the exemplary embodiments described above and various modifications and replacements are possible within the scope of the appended claims.

For example, the workflow system 100 in the description of the embodiments may be any system that provides a collective function with two or more devices operating in conjunction with each other. A term, workflow system, may be referred to as, for example, an apparatus cooperation system.

Additionally, the example illustrations of FIG. 6 to FIG. 8 of the configurations are illustrated in a simple manner in which the operation of each of the cloud server 70, the on-premise server 30, the cloud workflow management server 71, the administrator terminal 32, and the MFP 20 are divided according to main functions for easy understanding. The disclosure is not limited to how to divide or the names of each component. The processing of each of the cloud server 70, the on-premise server 30, the cloud workflow management server 71, the administrator terminal 32, and the MFP 20 may be further divided into a number of units of the processing according to contents of the processing. Alternatively, the processing may be divided in a manner that a unit of the processing may include the more number of units of processing.

Additionally, the workflow information receiving unit 45 is one example of processing information receiving means, the processing unit 74 of the cloud server 70 is one example of second processing means, the information acquisition unit 59 of the on-premise server 30 is one example of acquisition means, the processing unit 74 of the on-premise server 30 is one example of first processing means, the workflow control unit 64 of the on-premise server 30 is one example of processing controlling means, and the processing unit of the MFP 20 is one example of third processing means.

The control unit 52 of the administrator terminal 32 is one example of a definition information generating means, the workflow information transmission unit 53 is one example of transmitting means, and the workflow selection unit 56 is one example of receiving means. The on-premise workflow cooperative processing unit 77, the cloud workflow server cooperative processing unit 72, and the on-premise workflow server cooperative processing unit 73 are substantially the same means.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), DSP (digital signal processor), FPGA (field programmable gate array) and conventional circuit components arranged to perform the recited functions.

Although the embodiments of the disclosure have been described and illustrated above, such description is not intended to limit the disclosure to the illustrated embodiments. Numerous additional modifications and variations are possible in light of the above teachings. It is therefore to be understood that within the scope of the appended claims, the embodiments may be practiced otherwise than as specifically described herein. For example, elements and/or features of different illustrative embodiments may be combined with each other and/or substituted for each other within the scope of this disclosure and appended claims.

What is claimed is:

1. A system comprising:
first apparatus disposed within a site, the first apparatus including:
first circuitry; and
a first memory; and
a second apparatus disposed outside of the site and communicably connected with the first apparatus through a network, the second apparatus including:
second circuitry to receive definition information defining a plurality of processes to be performed; and
a second memory to store the definition information,
wherein the first circuitry is configured to acquire the definition information from the second memory, and to store the acquired definition information in the first memory,
wherein the first circuitry and the second circuitry cooperate with each other to determine, for each one of the plurality of processes defined by the definition information, a device to execute the process according to the definition information and control the device to perform the process,
wherein, when the device to execute the process is disposed within the site, the first circuitry controls the device to perform the process, and
wherein, when the device to execute the process is disposed outside of the site, the second circuitry controls the device to perform the process.

2. The system of claim 1, further comprising:
a client terminal including third circuitry to:
display a screen for selecting, from among the plurality of processes, one or more first processes to be controlled by the first apparatus and one or more second processes to be controlled by the second apparatus, the first processes and the second processes being different at least in part, the screen being displayed based on screen data transmitted from any one of the first apparatus and the second apparatus; and
generate the definition information that defines the first processes and the second processes and an order of performing the plurality of processes, according to a user input that selects the first processes and the second processes and the order of performing the plurality of processes; and
transmit the definition information to the second apparatus through the network to cause the definition information to be stored in the second memory.

3. The system of claim 2,
wherein the third circuitry further receives a user input that selects a device to execute each one of the plurality of processes, and generates the definition information that further defines each device that executes each one of the plurality of processes according to the user input.

4. The system of claim 3,
wherein the first circuitry further acquires information indicating whether the definition information stored in the second memory of the second apparatus is updated at a predetermined time, and
receives the definition information that has been updated from the second apparatus, when the information indicates that the definition information is updated.

5. The system of claim 4,
wherein the first circuitry performs, when the definition information is acquired from the second memory, the plurality of processes defined in the definition information as a test, and
stores, when the plurality of processes are successfully performed, the definition information in the first memory.

6. The system of claim 1,
wherein one of the first circuitry and the second circuitry determines the device to execute each one of the plurality of processes.

7. The system of claim 1,
wherein the first circuitry further receives a user selection of a device to execute the process for each one of the plurality of processes to be performed according to the definition information stored in the memory, and
wherein the first circuitry and the second circuitry cooperate with each other to determine the device to execute the process according to the user selection.

8. The system of claim 1,
wherein the first apparatus is a server and the second apparatus is a server.

9. The system of claim 1,
wherein the first apparatus is an apparatus that receives a user instruction for executing the plurality of processes according to the definition information.

10. An apparatus disposed within a site and configured to communicate with an external information processing apparatus outside of the site through a network, comprising:
circuitry to acquire definition information from the external information processing apparatus, the definition information defining a plurality of processes to be performed; and
a memory to store the acquired definition information,
wherein the first circuitry determines, for each one of the plurality of processes defined by the definition information, a device to execute the process according to the definition information and control the device to perform the process,
wherein, when the device to execute the process is disposed within the site, the circuitry controls the device to perform the process, and
wherein, when the device to execute the process is disposed outside of the site, the circuitry causes the external apparatus to control the device to perform the process.

11. The apparatus of claim 10,
wherein the circuitry further acquires information indicating whether the definition information stored in the external information processing apparatus is updated at a predetermined time, and
receives the definition information that has been updated from the the external information processing apparatus, when the information indicates that the definition information is updated.

12. The apparatus of claim 10,
wherein the circuitry performs, when the definition information is acquired from the external information processing apparatus, the plurality of processes defined in the definition information as a test, and
stores, when the plurality of processes are successfully performed, the definition information in the memory.

13. A method, performed by an apparatus disposed within a site and configured to communicate with an external information processing apparatus outside of the site through a network, the method comprising:
acquiring definition information from the external information processing apparatus, the definition information defining a plurality of processes to be performed;
storing, in a memory, the acquired definition information;
determining, for each one of the plurality of processes defined by the definition information, a device to execute the process according to the definition information; and
controlling the device to perform the process;
wherein, when the device to execute the process is disposed within the site, the controlling is performed with the apparatus; and
wherein, when the device to execute the process is disposed outside of the site, the controlling is performed with the external apparatus.

14. The method of claim 13, further comprising:
acquiring information indicating whether the definition information stored in the external information processing apparatus is updated at a predetermined time, and
receiving the definition information that has been updated from the the external information processing apparatus, when the information indicates that the definition information is updated.

15. The method of claim 13, further comprising:
performing, when the definition information is acquired from the external information processing apparatus, the plurality of processes defined in the definition information as a test, and
storing, when the plurality of processes are successfully performed, the definition information in the memory.
